(19) United States
(12) Patent Application Publication
(10) Pub. No.: US 2022/0130016 A1
(43) Pub. Date: Apr. 28, 2022

(54) OPTICAL IMAGING PROCESSING METHOD AND STORAGE MEDIUM

(71) Applicant: SHANGHAI HARVEST INTELLIGENCE TECHNOLOGY CO., LTD., Shanghai (CN)

(72) Inventor: Zongwen CHEN, Shanghai (CN)

(73) Assignee: SHANGHAI HARVEST INTELLIGENCE TECHNOLOGY CO., LTD., Shanghai (CN)

(21) Appl. No.: 17/275,438

(22) PCT Filed: Jul. 3, 2019
(86) PCT No.: PCT/CN2019/094573

§ 371 Date: Dec. 22, 2021

(30) Foreign Application Priority Data
Sep. 12, 2018 (CN) 201811063227.5

(51) Int. Cl. G06T 5/00; G06T 5/50

(52) U.S. Cl. CPC G06T 5/002; G06V 40/13; G06T 2207/30004; G06T 5/50

(57) ABSTRACT

An optical imaging processing method and storage medium. Among them, the method includes a following step of obtaining an image that includes a biometric pattern, and further performs steps of detecting a bright spot on the image, and performing equalization on the bright spot and a neighborhood thereof. The abovementioned scheme can effectively utilize information of lens-free imaging to perform effective removal of image noise and bright and dark spots in a single image under lens-free imaging, so as to obtain a fingerprint portion block image of a single image that satisfies requirements for software processing, solving processing issues of biometric image in lens-free optical imaging.

### TECHNICAL FIELD

The present invention is related to a technical field of biometric identification, and especially related to a processing method for optical imaging of a biometric feature and a storage medium.

### BACKGROUND ART

As information technology develops, biometric identification technology exerts its more and more important effectiveness in an aspect of ensuring information security, wherein fingerprint recognition has become one of essential technical measures for identification and device-unlocking that are widely applied in the field of mobile Internet. Under the trend that the screen-to-body ratios of appliances get larger and larger, conventional capacitive fingerprint recognition has failed to meet the requirements, and ultrasonic fingerprint recognition has problems in aspects of technical maturity, cost, etc. Optical fingerprint recognition is expected to become a major technical scheme of under-screen fingerprint recognition.

An existing scheme for optical fingerprint recognition is based on principles of geometric optical lens imaging, and fingerprint modules used therein include components such as a microlens array and an optical spatial filter, and have many drawbacks such as having complicated structure, thick module, small sensing range and high cost. In comparison to the existing optical fingerprint scheme, implementing lens-free under-screen optical fingerprint recognition through principles of total reflection imaging of physical optics has advantages such as having simple structure, thin module, large sensing range and low cost. However, ordinary uniform illumination light sources cannot satisfy requirements for the principles of total reflection imaging. Structured light is a light source necessary for lens-free under-screen optical fingerprint imaging scheme. The present invention provides a data processing method for lens-free under-screen optical fingerprint imaging with illumination of structured light.

### CONTENT OF INVENTION

Therefore, providing software and a method of imaging processing for performing specific process on biometric identification imaging under structured light such as array light source is needed.

In order to solve the abovementioned problem, the inventor provides an optical imaging processing method that includes a following step of obtaining an image which includes a biometric pattern, and that further performs steps of detecting a bright spot on the image; and performing equalization on the bright spot and a neighborhood thereof.

Specifically, performing equalization on the bright spot and a neighborhood thereof specifically includes a step of zeroing grayscale values of the bright spot and the neighborhood.

Preferably, performing equalization on the bright spot and a neighborhood thereof specifically includes steps of obtaining a grayscale value of a boundary between an outside area of the neighborhood of the bright spot and the neighborhood of the bright spot, and filling an area of the bright spot and the neighborhood with the grayscale value.

Further, the method further includes a step of filtering the image for denoising. Preferably, the method further includes a step of locating an origin, which specifically includes designating a vertical projection of a center of a light source onto a plane of a sensor as an origin of physical coordinates of the sensor, and designating in the image a pixel point, to which the origin of the physical coordinates of the sensor corresponds, as an origin of coordinates of the image, the bright spot being detected with the origin of the coordinates of the image serving as a center.

A storage medium for optical imaging processing stores a computer program. The computer program, when being operated, executes a following step of obtaining an image that includes a biometric pattern, and further performs steps of detecting a bright spot on the image, and performing equalization on the bright spot and a neighborhood thereof.

Further, performing equalization on the bright spot and a neighborhood thereof specifically executes a step of zeroing grayscale values of the bright spot and the neighborhood.

Preferably, performing equalization on the bright spot and a neighborhood thereof specifically executes steps of obtaining a grayscale value of a boundary between an outside area of the neighborhood of the bright spot and the neighborhood of the bright spot, and filling an area of the bright spot and the neighborhood with the grayscale value.

Optionally, the computer program, when being operated, further executes a step of filtering the image for denoising.

Further, the computer program, when being operated, further executes a step of locating an origin, which specifically includes designating a vertical projection of a center of a light source onto a plane of a sensor as an origin of physical coordinates of the sensor, and designating in the image a pixel point, to which the origin of the physical coordinates of the sensor corresponds, as an origin of coordinates of the image, the bright spot being detected with the origin of the coordinates of the image serving as a center.

An optical imaging processing method includes following steps of obtaining multiple biometric images; performing image restoration according to various so images' origins of coordinates serving as centers, stitching the restored biometric images to obtain a synthesized biometric image, dividing the synthesized biometric image into a number of local regions, finding an average value of grayscale values of the local region, calculating an average grayscale value of the synthesized biometric image, and performing on each pixel in the local region steps of being divided by the average value of grayscale values of the local region and then being multiplied by the average grayscale value of the synthesized biometric image.

Further, the local regions include the synthesized biometric image's rows, columns, or block regions having preset size and shape.

Specifically, for each local region, steps of finding an average value of grayscale values of the local region, calculating the average grayscale value of the synthesized biometric image, and performing on each pixels in the local region steps of being divided by the average value of grayscale values of the local region and then being multiplied by the average grayscale value of the synthesized biometric image are performed.

Optionally, a step of filtering the synthesized biometric image for denoising is further performed.

A storage medium for optical imaging processing stores a computer program. The computer program, when being operated, executes following steps of obtaining multiple biometric images, performing image restoration according to various images' origins of coordinates serving as centers, stitching the restored biometric images to obtain a synthesized biometric image; and further executes steps of dividing the synthesized biometric image into a number of local regions, finding an average value of grayscale values of one of the local region, calculating an average grayscale value of the synthesized biometric image, and performing on each pixel in the local region steps of being divided by the average value of grayscale values of the local region and then being multiplied by the average grayscale value of the synthesized biometric image.

Further, the local regions include the synthesized biometric image's rows, columns or block regions having preset size and shape.

Specifically, the computer program, when being operated, executes, for each local region, following steps of finding an average value of grayscale values of the local region, calculating the average grayscale value of the synthesized biometric image, and performing on each pixels in the local region steps of being divided by the average value of grayscale values of the local regions and then being multiplied by the average grayscale value of the synthesized biometric image.

Optionally, the computer program, when being operated, further executes a following step of filtering the synthesized biometric image for denoising.

Distinguished from existing technologies, the abovementioned technical scheme can effectively utilize information of lens-free imaging to perform effective removal of image noise and bright and dark spots in a single image under lens-free imaging, so as to obtain a fingerprint portion block image of a single image that satisfies software processing requirements. Further, obtaining complete image information by stitching allows a whole fingerprint image to be correctly generated, is adapted to a magnification coefficient for lens-free imaging, obtains a synthesized fingerprint image having a suitable ratio and a suitable size, removes distortion and removes noise, facilitating further implementation of comparison and identification on a fingerprint image.

### DESCRIPTION OF ACCOMPANYING FIGURES

FIG. 1 is a flow chart of an optical imaging processing method described in the section of specific implementation manner;

FIG. 2 is a structural diagram of lens-free optical imaging described in the section of specific implementation manner;

FIG. 3 is a schematic diagram of a single image described in the section of specific implementation manner;

FIG. 4 is a flow chart of an optical imaging processing method described in the section of specific implementation manner;

FIG. 5 is a diagram of an effect of normalization on a synthesized fingerprint image described in the section of specific implementation manner

### SPECIFIC IMPLEMENTATION MANNER

In order to describe the technical content, structural features, achieved goals and effects of the technical scheme(s) in detail, the following provides detailed description in combination with specific embodiments and the accompanying figures.

The purpose of the present technical invention is achieved by the following technical schemes:

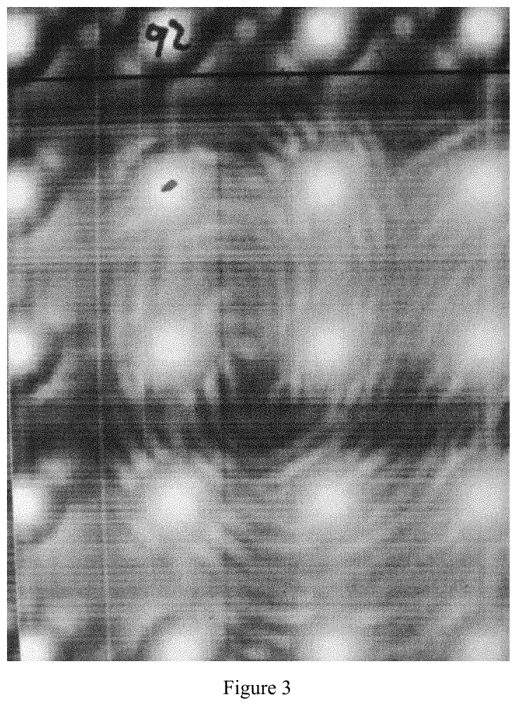

Here, please refer to FIG. 2. In an embodiment illustrated in FIG. 2, a schematic diagram of lens-free under-screen optical imaging of a biometric feature realized by using principles of total reflection imaging is illustrated. The biometric feature in the drawings and following description is exemplarily a fingerprint. However, it would be clear enough to achieve if the fingerprint is replaced by a biometric pattern, such as a palm print, a foot print, a toe print, retina, iris, etc. When we want to image a point A on a cover glass or other transparent medium which is pressed by a finger to a point B on a surface of a sensor, light emitted from a light-emitting point O on a light-emitting layer exactly satisfies the requirement according to the conditions for total reflection. Because an under-screen space is very small and a range illuminated by a single point light source is very small, multiple separate point light sources (e.g., dot-matrix light sources) have to be used to simultaneously illuminate the finger to satisfy requirements of fast under-screen fingerprint imaging.

However, each point light source O forms an image at a position O′ on the sensor directly below (not total reflection imaging), and the fingerprint at a position A′ directly above the point light source O cannot realize total reflection imaging because an incident angle of the light is smaller than a critical angle. In this way, the multiple point light sources form a dot matrix and simultaneously illuminate the fingerprint. On the surface of the sensor, there is not only an image of the fingerprint formed by total reflection, but also an image formed by light emitted straight down by the point light sources. Missions of data processing are (1) using a variety of algorithms to remove the image of the point light sources from the image of the fingerprint, without leaving any obvious trace; (2) seamlessly stitching all images of the fingerprint formed by illumination of each dot-matrix light source; and (3) removing all kinds of noises in a stitched image of the fingerprint to guarantee that a signal-to-noise ratio of the image of the fingerprint achieves requirements for fingerprint identification.

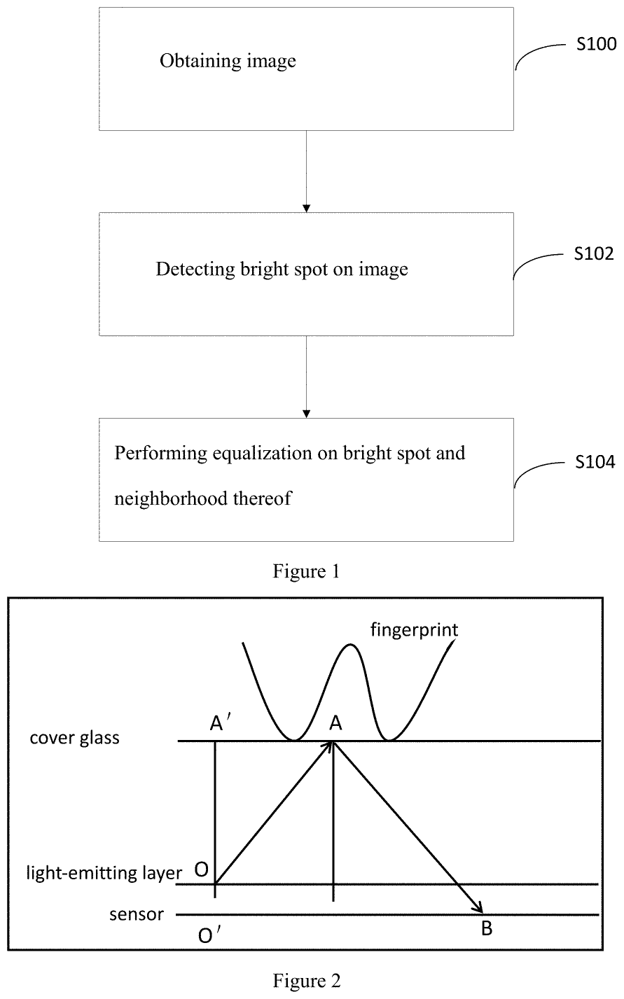

Based on the above statements, the present invention provides an optical imaging processing method that includes, as shown in FIG. 1, a following step of S100 obtaining an image which includes a fingerprint pattern, and that further performs steps of S102 detecting a bright spot on the image, and S104 performing equalization on the bright spot and a neighborhood thereof. In our embodiment, transparent medium, such as the cover glass as shown in FIG. 2, is disposed on an upper part of a device, a fingerprint identification area is disposed on an upper part of the transparent medium, and a light-emitting unit (or called a light source) is disposed below the transparent medium. The device further includes a sensing unit. The sensing unit is disposed below the fingerprint identification area for obtaining fingerprint information on the fingerprint identification area. The light-emitting unit herein may be an LED, an OLED or the like, and is preferably an AMOLED screen or a similar light source array. Since OLED is a self-luminous component and can transmit light in 360 degrees, and hence brings out, on the sensing unit directly below, a bright spot which hides detailed information of the fingerprint pattern and influences identification of the fingerprint pattern. For such specific situation, we call, for ease of recognition, the image obtained in step S100 as a single image. The so-called single image may be a fingerprint pattern sensed by a sensor array (or called a sensing unit) of some size, wherein, according to different sizes of a sensed zone of this single image, different numbers of images of point light sources, i.e., bright spots, may be included. In an embodiment as shown in FIG. 3, we can see that there is an apparent black interspace between upper and lower blocks. The image between the interspaces includes the information of the fingerprint pattern, also includes a number (e.g., four or six) of bright spots, can be divided according to demand, and serves as the “single image” described in this embodiment. Regarding the single image thus inputted, we have to process it, including identifying bright spots on the image and performing image optimization on the bright spots or on the bright spots and their neighborhoods. There may be many kinds of methods for detecting a bright spot. For example, pure mathematical methods are exemplarily described as follows:

1) setting a grayscale threshold, and determining a set (or a connected region) of image points each greater than the grayscale threshold as a bright spot when an area of the set of image points is greater than another threshold;

2) detecting grayscale gradients, and if there exists a closed region, in which all grayscale gradients are negative, grayscale gradients at a boundary of which are zeros, and a ratio of errors in longest line segments that can be drawn in different angles with the boundary of which is not greater than a circle-like shape determination threshold (e.g., 8%-10%), determining the region as a bright spot;

3) other methods of combining grayscale threshold and grayscale gradient or combining connected region area determination and region shape determination.

The neighborhood is a region neighboring on the bright spot and having a range of size that is predetermined under a preset rule, and can be defined by predetermined radius, shape, or grayscale threshold, and the range thereof can be automatically adjusted based on requirements of different preset rules. Preferably, the preset rule may be: a region, from the boundary of the bright spot outward, where a local maximum of grayscale gradient appears for the first time. Since grayscale values would gradually decrease away from a center of the bright spot, there will be a first minimum. At this moment, it can be regarded as entering a dark spot region. The dark spot region herein is the result of insufficient reflection of light not achieving a total reflection angle. Thereafter, it gradually becomes brighter and a grayscale maximum appears, and we define a portion within this as the neighborhood of the bright spot. Our method is to eliminate, through equalization, influence of the bright spot and the neighborhood thereof on fingerprint identification.

Therefore, in some specific embodiments, performing equalization on the bright spot and a neighborhood thereof may include a step of zeroing all grayscale values of the bright spot and the neighborhood. Zeroing all grayscale values makes the region become all black. Although it is also unable to reveal details of fingerprint, zeroing is able to eliminate influence and interference of information of the region on follow-up fingerprint identification, satisfying requirements of single-image invalid-information filling. Equalization may also be realized by taking the following approach: obtaining a grayscale value of a boundary between an outside area of the neighborhood of the bright spot and the neighborhood of the bright spot, and filling an area of the bright spot and the neighborhood with the grayscale value. For example, it may be to obtain grayscale values of all boundary pixels at the boundary of the bright spot and the neighborhood thereof, and after finding an average, to replace grayscale values of all pixels in the bright spot and the neighborhood of the bright spot with the average. It also may be to perform boundary pixel extraction on a boundary block, and to find a grayscale average of boundary pixels of the block to fill bright spots and neighborhoods of the bright spots in the block. The block may be a sector, a triangle, a rectangle or other polygons. By such equalization filling procedure, the technical effects of eliminating bright spots and removing influence and interference of the information of the region on fingerprint identification can also be achieved.

In a preferred embodiment, we further include a step of filtering the image for denoising. Our method usually designs multiple point light sources directly. Effective identification areas of the point light sources are limited, but light after experiencing multiple times of total reflection may still exert influence on sensor arrays in other areas, resulting in background noise which belongs to inherent system errors. In regard to removing such kind of inherent systematic errors, existing wavelet denoising software of image processing can be used directly to perform this process. Various kinds of filtering denoising software may be utilized for denoising herein. In a preferred embodiment, a base vector “db45” may be utilized for decomposing an image and removing high frequency and low frequency information so as to achieve an object of eliminating bright spots. This method is suitable for a situation where a dot matrix of illuminating light sources is relatively dense, and even in some situations, may substitute for the equalization process in the above-mentioned method for the bright spots and neighborhoods.

In some other specific embodiments, we further perform a step of locating an origin, which specifically includes designating a vertical projection of a center of a light source onto a plane of sensor as an origin of physical coordinates of the sensor, and designating in the image a pixel point, to which the origin of the physical coordinates of the sensor corresponds, as an origin of coordinates of the image, and detecting the bright spot and its neighborhood with the origin of the coordinates of the image serving as a center. The principle for doing so lies in that, it can be found in FIG. 1 that the bright spot must strictly appear at the dot o′ under the sensor, and we can observe in FIG. 3 that the bright spot is larger and more apparent than fingerprint information obstructed by it. In a specific embodiment, locating an origin of coordinates is in fact to locate a location of the center of the light source in the directly-below projection corresponding to the center of the bright spot in the image. Based on locating the origin, detection and identification of the bright spots in the “single image” can be performed better. For example, the aforementioned method of detection of the grayscale threshold or grayscale gradient change can be realized by detecting radially outward with the located origin serving as a center. By using the abovementioned origin-locating, the problem of detection optimization for a bright spot and a surrounding region of dark spots in optical imaging processing can be better solved.

The present invention further provides a storage medium for optical imaging processing, which stores a computer program. The computer program, when being operated, executes following steps of obtaining an image that includes a biometric pattern, and further performing steps of detecting a bright spot on the image and performing equalization on the bright spot and a neighborhood thereof.

Further, performing equalization on the bright spot and the neighborhood thereof specifically executes a step of zeroing grayscale values of the bright spot and the neighborhood.

Preferably, performing equalization on the bright spot and the neighborhood thereof specifically executes steps of obtaining a grayscale value of a boundary between an outside area of the neighborhood of the bright spot and the neighborhood of the bright spot, and filling an area of the bright spot and the neighborhood with the grayscale value.

Optionally, the computer program, when being operated, further executes a step of filtering the image for denoising.

Further, the computer program, when being operated, further executes a step of locating an origin, which specifically includes designating a vertical projection of a center of a light source onto a plane of sensor as an origin of physical coordinates of the sensor, designating in the image a pixel point, to which the origin of the physical coordinates of the sensor corresponds, as an origin of coordinates of the image, and detecting the bright spot with the origin of the coordinates of the image serving as a center.

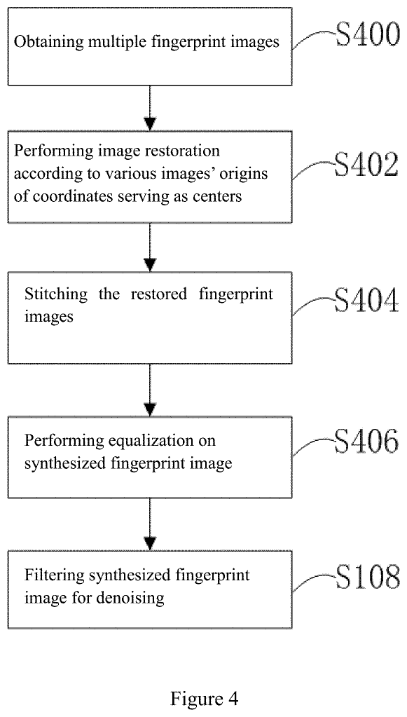

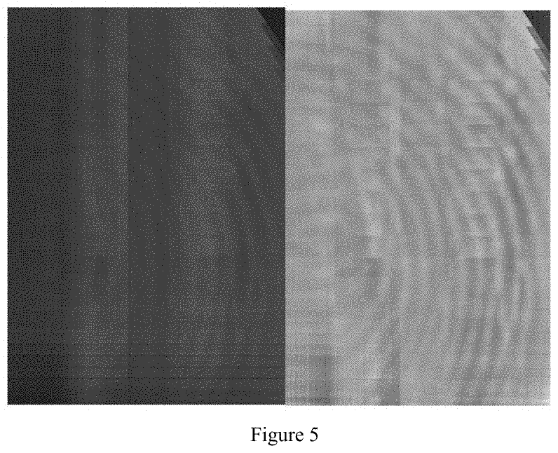

In an embodiment illustrated in FIG. 4, we further perform an optical imaging processing method which is used to perform a visualization process on a projection, onto the sensing unit, of fingerprint information that has been identified by the array of the point light sources. In this embodiment, the optical imaging processing method is based on the following assumptions: material fingerprint images are scan results based on the same fingerprint, and effective image division have been performed on the material fingerprint images based on an effective region that can be captured by different point light sources. The single image discussed herein is in a state of including only one origin corresponding to a point light source.

In this embodiment, the biometric image is still exemplified as the fingerprint image. The optical imaging processing method includes the following steps: S400 obtaining multiple fingerprint images; S402 performing image restoration according to various images' origins of coordinates serving as centers; S404 stitching the restored fingerprint images to obtain a synthesized fingerprint image; and S406 performing a normalization operation on the synthesized fingerprint image.

Performing restoration on multiple fingerprint images according to central origins specifically is that, since a division result of each image is assumed to include a bright spot, i.e., a located origin, the image we obtained is an enlarged fingerprint pattern based on principles of total reflection, and the enlarged corresponding origin is a central point of the bright spot. Because a main information-exhibiting area of each fingerprint is not fixed relative to the origin thereof, a certain amount of distortion would arise in aspect of sensing by the sensor. Performing image restoration on each image with the located origin can effectively restore fingerprint information, prevent distortion, and present the original appearance of the fingerprint better. In regard to how to divide a single image and how to reserve as much information as possible during restoration based on the origin, we also possess corresponding processing methods. However, these are not critical to substantial content of the present patent, and will not be further discussed herein.

Performing a normalization operation herein is specifically to divide the synthesized fingerprint image into a number of local regions, find an average value of grayscale values of the local region, calculate an average grayscale value of the synthesized fingerprint image, and perform on each pixel in the local region(s) steps of being divided by the average value of grayscale values of the local region(s) and then being multiplied by the average grayscale value of the synthesized fingerprint image.

That is to say, for a certain region of the image, operations are performed: finding an average grayscale value of a row, a column and a block region in the image, and dividing a grayscale value of each pixel in this region by the average value, and multiplying the same by the average grayscale value of the whole image. The formula below is followed:

$$\overline{A} ( i , j ) = \frac{{\sum }_{1}^{i} {\sum }_{1}^{j} A ( i , j )}{{\sum }_{1}^{i} A ( i , j ) * {\sum }_{1}^{j} A ( i , j )}$$

wherein A(i, j) represents a pixel grayscale value at the i^{th} row and the j^{th} column, and Ā(i, j) represents a normalized grayscale value. A final result of normalization is illustrated as shown in FIG. 5, where FIG. 5 illustrates on the left side influence of fingerprint before normalization, and on the right side effect after normalization. It can be observed that clarity and consistency of brightness are obviously enhanced.

In a further embodiment, we can also perform local region division for the synthesized fingerprint image. Therefore, the method of the present invention further includes a step of dividing the synthesized fingerprint image into local regions based on rows, or performs a step of dividing the synthesized fingerprint image into local regions based on columns, or performs a step of separating the synthesized

fingerprint image into different rectangles based on stitching positions for dividing into local regions, or the like. Therefore, in our technical scheme, the local regions include the synthesized fingerprint image's some rows, some columns, or block regions having preset size and shape. The local regions are favorably to be selected across multiple original material fingerprint images.

In a preferable embodiment, the normalization operation can be performed on a number of selected local regions. Further steps are performed: receiving a selection operation by a user on the local regions of the synthesized fingerprint image, and performing normalization operation steps based on the local regions selected by the user. Of course, it is also possible to perform the normalization operation on all local regions. That means, for each local region, steps are performed: finding an average value of grayscale values of the local region, and calculating an average grayscale value of the synthesized fingerprint image. For all pixels in the local region, steps are performed: being divided by the average grayscale value of the local region, and then being multiplied by the average grayscale value of the synthesized fingerprint image. The average grayscale value of the synthesized fingerprint image herein is preferable an initial average grayscale value, or may be an average grayscale value of a new synthesized fingerprint image after each local region has been normalized. Through the abovementioned normalization operation, a brightness relationship between a local portion and the whole of the synthesized fingerprint image can be more balanced, and the problem that a fingerprint cannot be effectively identified because of a too strong contrast among some portions would not arise.

Optionally, a step is further performed: S408 filtering the synthesized fingerprint image for denoising. Herein, removing noise from the synthesized fingerprint image mainly includes wavelet variation, Fourier filtering, or Gaussian filtering followed by binarization. Similar to what have been previously mentioned, when wavelet transformation is adopted, the base vector is selected as “db45” for removing high-frequency and low-frequency information. Fourier filtering removes high-frequency central information and low-frequency bilateral information. Gaussian-filtering binarization is to, after locally normalizing an obtained image, use a bilateral algorithm (a standard algorithm of image processing) of Gaussian functions and performing local binarization. Through the abovementioned steps of denoising, we can reduce noise interference in the whole synthesized fingerprint image, reserve effective fingerprint information in the final fingerprint image, and remove traces of stitching in the synthesized fingerprint image better. Because the traces of stitching can be regarded as noise in a sense, performing filtering can remove the traces of stitching better at one time, satisfying technical requirements of biological fingerprint image processing in optical imaging.

In some other embodiments, another storage medium for optical imaging processing that stores a computer program is further provided. The computer program, when being operated, executes following steps of: obtaining multiple biometric images; performing image restoration according to various images' origins of coordinates serving as centers; and stitching the restored biometric images to obtain a synthesized biometric image.

Steps are further executed: dividing the synthesized biometric image into a number of local regions; finding an average value of grayscale values of the local region; calculating an average grayscale value of the synthesized biometric image; and performing on each pixel in the local region steps of being divided by the average value of grayscale values of the local region and then being multiplied by the average grayscale value of the synthesized biometric image.

Further, the local regions include the synthesized biometric image's rows, columns, or block regions having preset size and shape.

Specifically, the computer program, when being operated, executes, for each of the local regions, following steps of: finding an average value of grayscale values of the local region; calculating the average grayscale value of the synthesized biometric image; and performing on each pixel in the local region steps of being divided by the average value of grayscale values of the local region and then being multiplied by the average grayscale value of the synthesized biometric image.

Optionally, the computer program, when being operated, further executes a following step of filtering the synthesized biometric image for denoising.

It needs to be made clear that although description with respect to each above-mentioned embodiment has been given in this specification, the protected patent scope of the present invention is not limited thereby. Therefore, based on the novel idea of the present invention, any alteration or modification made to the embodiments described in this specification, or equivalent structure or equivalent flow change that is made by using the content of the specification and the accompanying figures of the present invention, and directly or indirectly applying the above-mentioned technical schemes in other related technical fields, are each included in the protected patent scope of the present invention.

1. An optical imaging processing method, characterized by comprising a following step of obtaining an image that includes a biometric pattern, and by further performing steps of detecting a bright spot on the image, and performing equalization on the bright spot and a neighborhood thereof.

2. The optical imaging processing method as claimed in claim 1, characterized in that performing equalization on the bright spot and a neighborhood thereof specifically includes a step of zeroing grayscale values of the bright spot and the neighborhood.

3. The optical imaging processing method as claimed in claim 1, characterized in that performing equalization on the bright spot and a neighborhood thereof specifically includes steps of obtaining a grayscale value of a boundary between an outside area of the neighborhood of the bright spot and the neighborhood of the bright spot, and filling an area of the bright spot and the neighborhood with the grayscale value.

4. The optical imaging processing method as claimed in claim 1, characterized by further comprising a step of filtering the image for denoising.

5. The optical imaging processing method as claimed in claim 1, characterized by further comprising a step of locating an origin, which specifically includes designating a vertical projection of a center of a light source onto a plane of a sensor as an origin of physical coordinates of the sensor, and designating in the image a pixel point, to which the origin of the physical coordinates of the sensor corresponds, as an origin of coordinates of the image, the bright spot being detected with the origin of the coordinates of the image serving as a center.

6. A storage medium for optical imaging processing, characterized by storing a computer program, the computer program, when being operated, executing a following step of obtaining an image that includes a biometric pattern, and further performing steps of detecting a bright spot on the image, and performing equalization on the bright spot and a neighborhood thereof.

7. The storage medium for optical imaging processing as claimed in claim 6, characterized in that performing equalization on the bright spot and a neighborhood thereof specifically executes a step of zeroing grayscale values of the bright spot and the neighborhood.

8. The storage medium for optical imaging processing as claimed in claim 6, characterized in that performing equalization on the bright spot and a neighborhood thereof specifically executes steps of obtaining a grayscale value of a boundary between an outside area of the neighborhood of the bright spot and the neighborhood of the bright spot, and filling an area of the bright spot and the neighborhood with the grayscale value.

9. The storage medium for optical imaging processing as claimed in claim 6, characterized in that the computer program, when being operated, further executes a step of filtering the image for denoising.

10. The storage medium for optical imaging processing as claimed in claim 6, characterized in that the computer program, when being operated, further executes a step of locating an origin, which specifically includes designating a vertical projection of a center of a light source onto a plane of sensor as an origin of physical coordinates of the sensor, and designating in the image a pixel point, to which the origin of the physical coordinates of the sensor corresponds, as an origin of coordinates of the image, the bright spot being detected with the origin of the coordinates of the image serving as a center.

11. An optical imaging processing method, characterized by comprising following steps of obtaining multiple biometric images, performing image restoration according to various images' origins of coordinates serving as centers, stitching the restored biometric images to obtain a synthesized biometric image,
dividing the synthesized biometric image into a number of local regions, finding an average value of grayscale values of the local region, calculating an average grayscale value of the synthesized biometric image, and performing on each pixel in the local region steps of being divided by the average value of grayscale values of the local region and then being multiplied by the average grayscale value of the synthesized biometric image.

12. The optical imaging processing method as claimed in claim 11, characterized in that the local regions include the synthesized biometric image's rows, columns, or block regions having preset size and shape.

13. The optical imaging processing method as claimed in claim 11, characterized by performing, for each local region, steps of finding an average value of grayscale values of the local region, calculating the average grayscale value of the synthesized biometric image, and performing on each pixel in the local region steps of being divided by the average value of grayscale values of the local region and then being multiplied by the average grayscale value of the synthesized biometric image.

14. The optical imaging processing method as claimed in claim 11, characterized by further performing a step of filtering the synthesized biometric image for denoising.

15. A storage medium for optical imaging processing, characterized by storing a computer program, the computer program, when being operated, executing following steps of obtaining multiple biometric images, performing image restoration according to various images' origins of coordinates serving as centers, stitching the restored biometric images to obtain a synthesized biometric image,
further executing steps of dividing the synthesized biometric image into a number of local regions, finding an average value of grayscale values of the local region, calculating an average grayscale value of the synthesized biometric image, and performing on each pixel in the local region steps of being divided by the average value of grayscale values of the local region and then being multiplied by the average grayscale value of the synthesized biometric image.

16. The storage medium for optical imaging processing as claimed in claim 15, characterized in that the local regions include the synthesized biometric image's rows, columns, or block regions having preset size and shape.

17. The storage medium for optical imaging processing as claimed in claim 15, characterized in that the computer program, when being operated, executes, for each local region, following steps of finding an average value of grayscale values of the local region, calculating the average grayscale value of the synthesized biometric image, and performing on each pixel in the local region steps of being divided by the average value of grayscale values of the local region and then being multiplied by the average grayscale value of the synthesized biometric image.

18. The storage medium for optical imaging processing as claimed in claim 15, characterized in that the computer program, when being operated, further executes a following step of filtering the synthesized biometric image for denoising.

19. The optical imaging processing method as claimed in claim 13, characterized by further performing a step of filtering the synthesized biometric image for denoising.

20. The storage medium for optical imaging processing as claimed in claim 17, characterized in that the computer program, when being operated, further executes a following step of filtering the synthesized biometric image for denoising.
